(19) United States
(12) Patent Application Publication
(10) Pub. No.: US 2014/0119539 A1
(43) Pub. Date: May 1, 2014

(54) ELECTRONIC DEVICE AND DECRYPTING METHOD

(71) Applicant: KABUSHIKI KAISHA TOSHIBA, Tokyo (JP)

(72) Inventor: Qi Zhang, Tokyo (JP)

(73) Assignee: KABUSHIKI KAISHA TOSHIBA, Tokyo (JP)

(21) Appl. No.: 13/762,816

(22) Filed: Feb. 8, 2013

(30) Foreign Application Priority Data
Oct. 31, 2012 (JP) 2012-240737

(51) Int. Cl. H04L 9/08

(52) U.S. Cl. CPC H04L 9/0861
USPC 380/44

(57) ABSTRACT

According to one embodiment, an electronic apparatus includes an acquisition module, a first generator, a second generator, and an encrypting processor. The acquisition module acquires a first data file which is encrypted and a first character string corresponding to the first data file. The first generator generates first handwriting information includes a plurality of stroke data corresponding to a plurality of strokes. The first handwriting information is obtainable by inputting the first character string by handwriting. The second generator generates a first key using the first handwriting information. The encrypting processor decrypts the first data file using the first key.

### CROSS-REFERENCE TO RELATED APPLICATIONS

This application is based upon and claims the benefit of priority from Japanese Patent Application No. 2012-240737, filed Oct. 31, 2012, the entire contents of which are incorporated herein by reference.

### FIELD

Embodiments described herein relate generally to a data file encrypting or decrypting method.

### BACKGROUND

When a data file is attached to an electronic mail and transmitted, the data file is encrypted and attached to the electronic mail to protect the secrecy of the file. Then, information used for decrypting the data file is separately transmitted to the partner.

In the above method, transmission is made twice to separately transmit the encrypted data file and information for decrypting the data file.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an example block diagram showing one example of a system according to one embodiment.

FIG. 2 is an example perspective view showing the external appearance of an electronic apparatus according to the present embodiment.

FIG. 3 is an example block diagram showing the system configuration of the electronic apparatus according to the present embodiment.

FIG. 4 is an example block diagram showing the configuration of a compression/expansion application program.

FIG. 5 is an example flowchart for illustrating the procedure of transmitting a compressed and encrypted data file.

FIG. 6 is an example view showing an example of a handwritten page displayed on an LCD.

FIG. 7 is an example view showing the state in which a compressed and encrypted data file is transmitted to user B.

FIG. 8 is an example flowchart for illustrating the procedure of decrypting and expanding a compressed and encrypted data file.

FIG. 9 is an example view showing a handwritten input column and message displayed on the LCD.

FIG. 10 is an example view showing a case where the electronic mail is intercepted by user C.

### DETAILED DESCRIPTION

Various embodiments will be described hereinafter with reference to the accompanying drawings.

In general, according to one embodiment, an electronic apparatus includes an acquisition module, first generator, a second generator, and an encrypting processor. The acquisition module is configured to acquire a first data file which is encrypted and a first character string corresponding to the first data file. The first generator is configured to generate first handwriting information comprising a plurality of stroke data corresponding to a plurality of strokes. The first handwriting information is obtainable by inputting the first character string by handwriting. The second generator is configured to generate a first key using the first handwriting information. The encrypting processor is configured to decrypt the first data file using the first key.

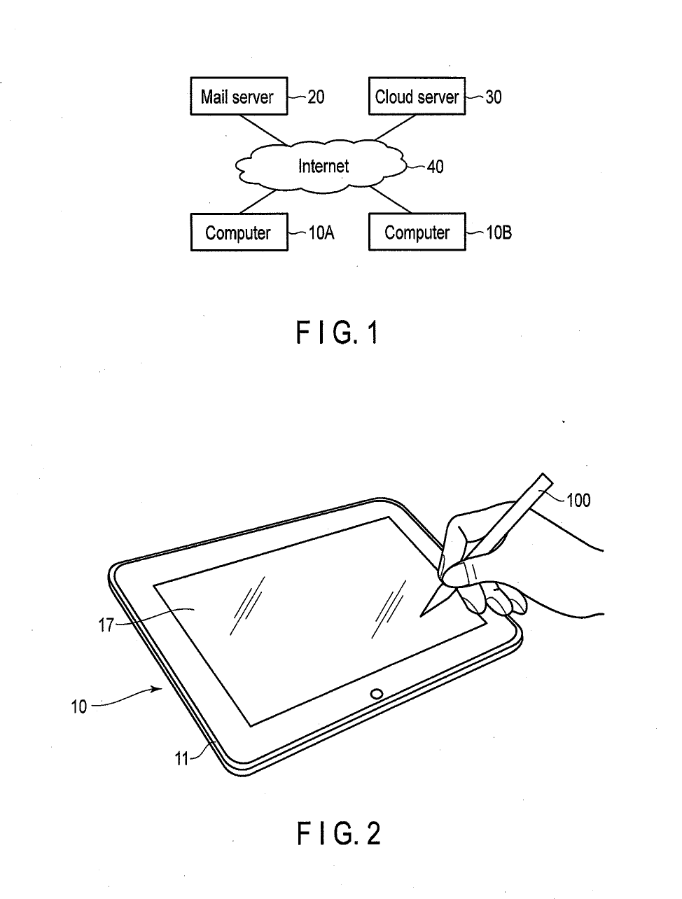

FIG. 1 is a block diagram showing a system including an electronic apparatus according to one embodiment. For example, the electronic apparatus is a stylus-based mobile electronic apparatus with which data can be handwritten by use of a stylus or finger. The electronic apparatus can be realized as a tablet computer, notebook personal computer, smartphone, PDA or the like. In the following description, a case wherein the electronic apparatus is realized as a tablet computer is assumed.

The system includes a first tablet computer 10A, second tablet computer 10B, mail server 20, cloud server 30 and the like.

Data handwritten by the user of the first tablet computer 10A and input is stored in the cloud server 30. The mail server 20 is a server computer used for distributing electronic mails.

FIG. 2 is a perspective view showing the external appearance of a tablet computer (first tablet computer 10A, second tablet computer 10B) 10 according to one embodiment. The tablet computer 10 is a mobile electronic apparatus that is called a tablet or slate computer and includes a main body 11 and touchscreen display 17 as shown in FIG. 2. The touchscreen display 17 is mounted to be superimposed on the upper surface of the main body 11.

The main body 11 has a thin box-shaped casing. A flat panel display and a sensor configured to detect the contact position of a stylus or finger on the screen of the flat panel display are incorporated in the touchscreen display 17. For example, the flat panel display may be a liquid crystal display (LCD). As the sensor, for example, a capacitance type touchpanel, electromagnetic induction type digitizer or the like can be used. In the following description, a case wherein two types of sensors including the digitizer and touchpanel are both incorporated in the touchscreen display 17 is assumed.

Each of the digitizer and touchpanel is provided to cover the screen of the flat panel display. The touchscreen display 17 can detect not only the touch operation performed by the finger with respect to the screen but also the touch operation performed by means of a stylus 100 with respect to the screen. For example, the stylus 100 may be an electromagnetic induction stylus. The user can perform a handwriting input operation on the touchscreen display 17 by use of an external object (stylus 100 or finger). In the handwriting input operation, the locus of the movement of an external object (stylus 100 or finger) on the screen, that is, the locus (handwriting) of a stroke handwritten by the handwriting input operation is drawn on the real-time basis and, as a result, the locus of each stroke is displayed on the screen. The locus of the movement of the external object while the external object is kept contact with the screen corresponds to one stroke. A set of a large number of strokes corresponding to handwritten characters or figures, that is, a set of a large number of loci (handwriting) configures a handwritten document.

In this embodiment, the handwritten document is stored in a storage medium not as image data but as time-series information indicating a coordinate string of loci of the respective strokes and the relationship of the orders of the strokes. The time-series information generally means a set of time-series stroke data corresponding to a plurality of strokes. Each stroke data corresponds to a certain stroke and includes a coordinate data series (time-series coordinates) corresponding to respective points on the locus of the stroke. The order of the arrangement of the stroke data corresponds to the order of the strokes handwritten, that is, the order of making strokes.

The tablet computer 10 can read existing desired time-series information from the storage medium and display a handwritten document corresponding to the time-series information, that is, loci corresponding to a plurality of strokes indicated by the time-series information on the screen. Further, the tablet computer 10 has an editing function. The editing function makes it possible to delete or move desired strokes, desired handwritten characters or the like in the handwritten document that is now displayed according to the editing operation by the user using an “eraser” tool, range specifying tool and other various tools. Further, the editing function includes a function of erasing the history of several handwriting operations.

In this embodiment, the time-series information (handwritten document) can be managed as one page or a plurality of pages. In this case, a set of time-series information that fits in one screen may be recorded as one page by separating the time-series information (handwritten document) in the area unit that fits in one screen. Alternatively, the page size can be made variable. In this case, since the page size can be increased to an area larger than the size of one screen, the handwritten document with an area larger than the size of the screen can be handled as one page. When the whole portion of one page cannot be simultaneously displayed on the display, the page may be reduced or a portion to be displayed in the page may be moved by vertical and horizontal scrolling.

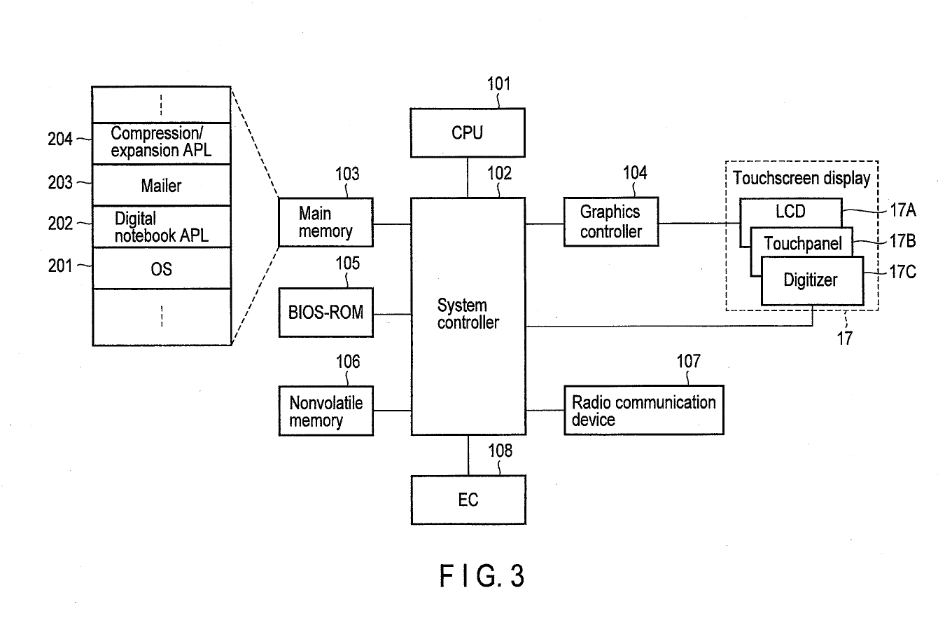

FIG. 3 is a diagram showing the system configuration of the tablet computer 10.

As shown in FIG. 3, the tablet computer 10 includes a central processing unit (CPU) 101, a system controller 102, a main memory 103, a graphics controller 104, a BIOS-ROM 105, a nonvolatile memory 106, a radio communication device 107, an embedded controller (EC) 108 and the like.

The CPU 101 is a processor that controls the operations of various modules in the tablet computer 10. The CPU 101 executes various software loaded from the nonvolatile memory 106 that is a storage device into the main memory 103. In the softwares, an operating system (OS) 201 and various application programs are contained. In the application programs, a digital notebook application program 202, a mailer 203 and a compression/expansion application program 204 are contained. The digital notebook application program 202 has a function of generating and displaying the handwritten document, a function of editing the handwritten document, a character-diagram recognition function and the like.

Further, the CPU 101 also executes a basic input/output system (BIOS) stored in the BIOS-ROM 105. The BIOS is a program for hardware control.

The system controller 102 is a device that connects the local bus of the CPU 101 to various components. In the system controller 102, a memory controller that controls access to the main memory 103 is also contained. Further, the system controller 102 has a function of making communications with the graphics controller 104 via a serial bus with conformant with the PCI EXPRESS standard.

The graphics controller 104 is a display controller that controls an LCD 17A used as a display monitor of the tablet computer 10. A display signal generated by the graphics controller 104 is sent to the LCD 17A. The LCD 17A displays a screen image based on the display signal. A touchpanel 17B and digitizer 17C are arranged on the LCD 17A. The touchpanel 17B is a capacitance-type pointing device used for inputting data on the screen of the LCD 17A. The contact position of the finger contacting the screen and the movement of the contact position are detected by the touchpanel 17B. The digitizer 17C is an electromagnetic-induction-type pointing device used for inputting data on the screen of the LCD 17A. The position (coordinates) of the stylus 100 contacting the screen and the movements of the position of the stylus 100 are detected by the digitizer 17C. The digitizer 17C outputs coordinates indicating the position of the stylus 100 on the screen.

The radio communication device 107 is a device configured to provide wireless communication such as wireless LAN or 3G mobile communication. The EC 108 is a single-chip microcomputer containing an embedded controller for power management. The EC 108 has a function of turning on or off the power source of the tablet computer 10 according to the operation of the power button by the user.

The digital notebook application program 202 performs the operation of generating, displaying and editing a handwritten document by using stroke data input by use of the touchscreen display 17. The touchscreen display 17 is configured to detect occurrence of events such as “touch”, “movement (slide)”, “release” and the like. “Touch” is an event indicating that an external object contacts the screen. “Movement (slide)” is an event indicating that the contact position is moved while the external object is kept contact with the screen. “Release” is an event indicating that the external object is separated from the screen.

The digital notebook application program 202 receives an even of “touch” or “movement (slide)” generated by the touchscreen display 17 to detect the handwriting operation. The coordinates of the contact position are contained in the “touch” event. The coordinates of the contact position of the movement destination are contained in the “movement (slide)” event. That is, the digital notebook application program 202 can receive a coordinate string corresponding to the locus of the movement of the contact position from the touchscreen display 17.

The digital notebook application program 202 receives a coordinate string from the touchscreen display 17 and displays the locus of each stroke handwritten by the handwriting operation using the stylus 100 or the like on the screen of the LCD 17A in the touchscreen display 17 based on the coordinate string. By the above process, the locus of the stylus 100, that is, the locus of each stroke while the stylus 100 is kept contact with the screen is drawn on the screen of the LCD 17A.

The digital notebook application program 202 receives the coordinate string output from the touchscreen display 17 and generates the above time-series information based on the coordinate string. In this case, time-series information, that is, coordinates corresponding to the respective points on the stroke and time stamp information may be temporarily stored in a work memory.

The digital notebook application program 202 stores the thus generated time-series information as a handwritten document (handwritten page) in the storage medium. As described above, the storage medium may be one of a storage device of the tablet computer 10, a storage device of a personal computer and a storage device of the cloud server 30.

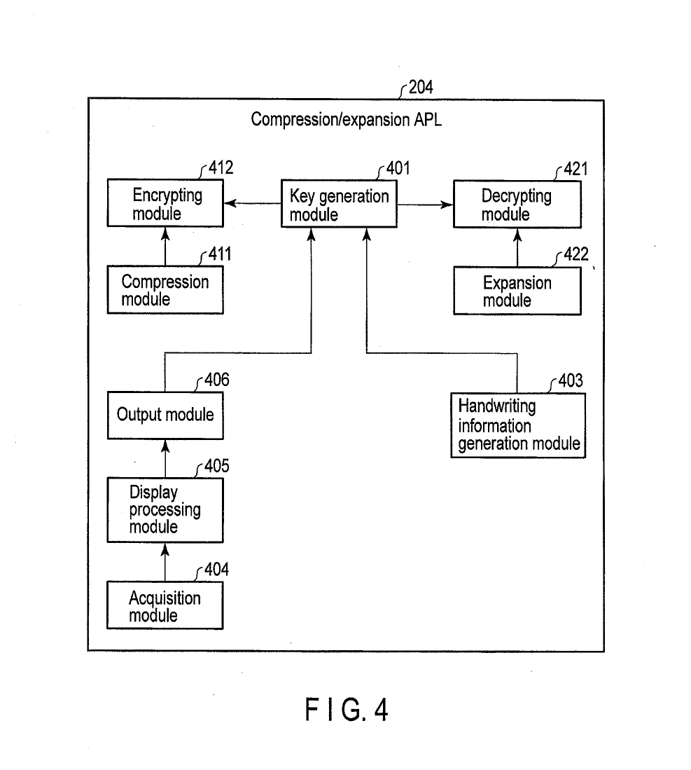

Next, the function and configuration of the compression/expansion application program 204 are explained with reference to FIG. 4.

The compression/expansion application program 204 includes a key generation module 401, a handwriting information generation module 403, a acquisition module 404, a display processing module 405, an output module 406, a compression module 411, an encrypting module 412, a decrypting module 421, an expansion module 422 and the like.

The key generation module 401 generates a key by using a preset algorithm according to handwriting information output from the handwriting information generation module 403 or acquisition module 404. As the preset algorithm, an algorithm used for, for example, fingerprint confirmation, face confirmation, iris confirmation, palm print confirmation, handwriting confirmation, biometrics and the like is used. The key generation module 401 may generate a password by using a preset algorithm according to handwriting information output from the handwriting information generation module 403 or acquisition module 404. Then, a key may be generated by use of the password. The handwriting information generation module 403 generates handwriting information. The handwriting information generation module 403 outputs the handwriting information to the key generation module 401. The acquisition module 404 acquires handwriting information from the cloud server 30. The acquisition module 404 outputs the acquired handwriting information to the key generation module 401.

The compression module 411 compresses a data file specified by the user. The encrypting module 412 encrypts the data file compressed by the compression module 411. The encrypting module 412 encrypts the data file by using a key generated by means of the key generation module 401.

The decrypting module 421 expands a data file specified by the user. The decrypting module 421 decrypts the data file by using a key generated by means of the key generation module 401. The expansion module 422 expands the data file decrypted by the decrypting module 421.

Next, a procedure for permitting the user using the computer 10A to transmit a compressed and encrypted data file with respect to the computer 10B by use of the mailer 203 and compression/expansion application program 204 is explained.

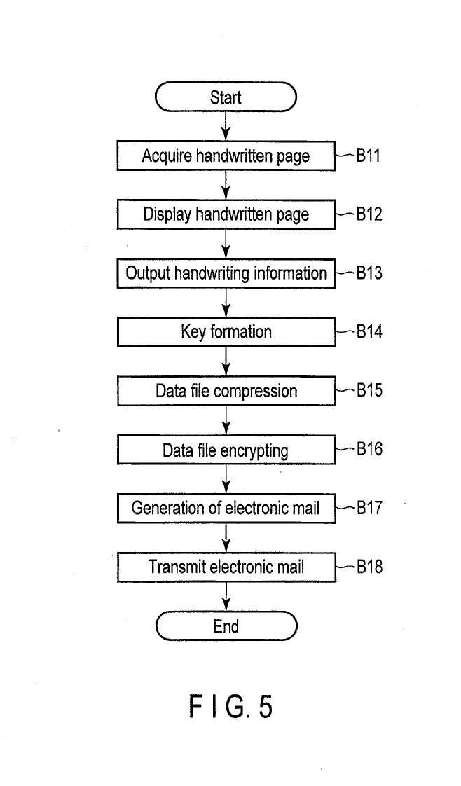

FIG. 5 is a flowchart for illustrating the procedure of transmitting a compressed and encrypted data file.

First, user A specifies a data file to be compressed and encrypted by performing the drag-and-drop operation and using a dialog box.

The acquisition module 404 acquires handwritten page data of user B specified by user A from the cloud server 30 (block B11). Handwritten page data previously stored in the nonvolatile memory 106 may be acquired instead of acquiring the handwritten page data from the cloud server 30.

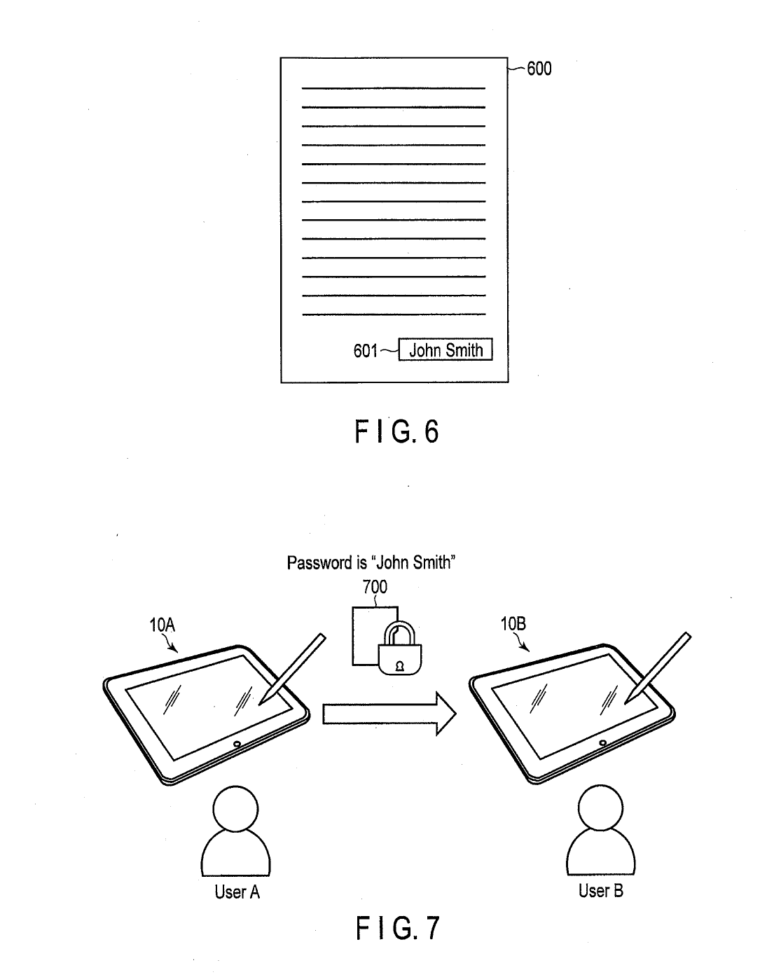

The display processing module 405 performs a process of displaying a handwritten page 600 shown in FIG. 6 on the LCD 17A based on the handwritten page data (block B12). User A specifies a handwriting area 601 that is converted into a password in the handwritten page 600. The output module 406 outputs handwriting information contained in the handwriting area 601 specified by user A to the key generation module 401 (block B13).

The key generation module 401 generates a key by using a preset algorithm based on the handwriting information (block B14). The key generation module 401 may generate a key by using a preset algorithm based on the handwriting information.

The compression module 411 compresses a data file specified by user A (block B15). The encrypting module 412 encrypts the compressed data file by using a key generated by means of the key generation module 401 (block B16).

User A forms an electronic mail having a compressed and encrypted data file attached thereto and addressed to user B (block B17). In the text of the electronic mail, a character string corresponding to handwriting information contained in the specified area is described. For example, “Password is ‘John Smith’” is described. User A transmits an electronic mail having a compressed and encrypted data file 700 attached thereto to user B by using the mailer 203 as shown in FIG. 7 (block B18). The electronic mail addressed to user B is transmitted to the mail server 20.

Next, a procedure for permitting user B using the computer 10B to decrypt and expand a compressed and encrypted data file attached to the electronic mail by use of the mailer 203 and compression/expansion application program 204 is explained.

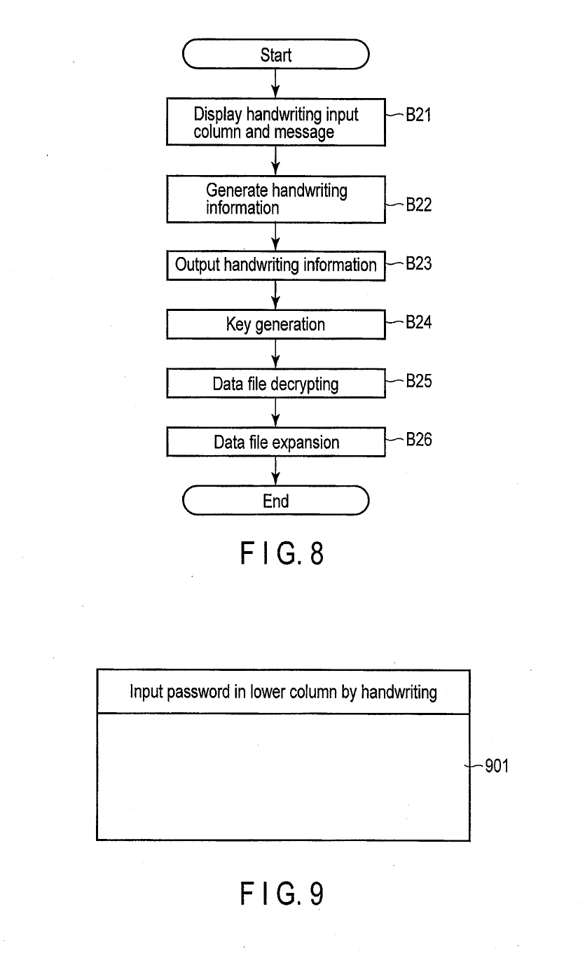

FIG. 8 is a flowchart for illustrating the procedure of decrypting and expanding the compressed and encrypted data file.

User B receives an electronic mail from the mail server 20 by use of the mailer 203 as acquisition means. An encrypted data file is attached to the electronic mail and a character sting corresponding to the data file is described therein. User B stores the compressed and encrypted data file attached to the electronic mail in a desktop, for example. User B specifies a compressed and encrypted data file by performing the drag-and-drop operation and using a dialog box.

As shown in FIG. 9, the handwriting information generation module 403 displays a handwriting input column 900 and a message of “Input password by handwriting in lower column” on the LCD 17A (block B21). User B inputs a text described in the electronic mail by handwriting.

When the text is input by handwriting in the handwriting input column, the handwriting information generation module 403 generates handwriting information (block S22). The handwriting information generation module 403 outputs the handwriting information to the key generation module 401 (block S23). The key generation module 401 generates a key by use of a preset algorithm according to the handwriting information (block S24). The key generation module 401 may generate a password by use of a preset algorithm according to the handwriting information.

The decrypting module 421 decrypts a data file specified by user B by use of a key generated by means of the key generation module 401 (block B25). The expansion module 422 expands the decrypted data file (block B26).

With the above process, a data file sent from user A can be decrypted and expanded.

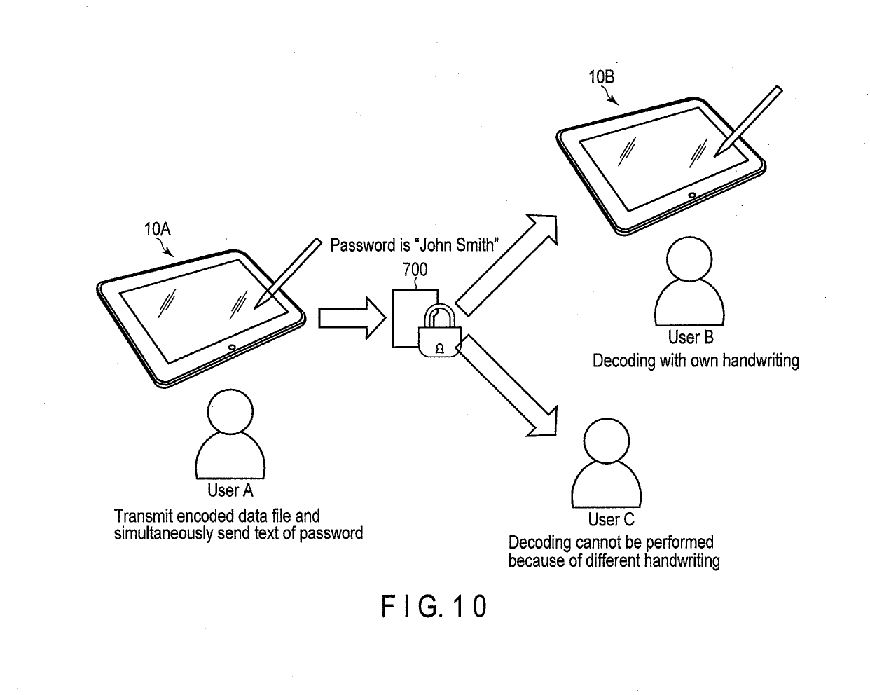

According to this embodiment, as shown in FIG. 10, since a data file cannot be decrypted because the handwriting of user C is different from the handwriting of user B even if the electronic mail is intercepted by user C, the secrecy of the data file can be protected even when the encrypted data file and information used for decrypting the data file are simultaneously handed over.

The text of the password may be attached to a compressed archive file as metadata without describing the same in the text of the mail. When user B decrypts and expands the data file, the compression/expansion application program 204 recognizes metadata and provides a necessary password to user B. Further, user A can specify his own handwriting in a password and cut out and use the password according to the handwriting information of user A that the receiver has.

The key generation module 401 generates a key different from the original key when the password described in the mail is input by handwriting with the handwriting different from that of user B. When the key different from the original key is generated, the decrypting module 421 cannot decrypt the data file.

An encrypted data file and password can be acquired by use of different methods. For example, an encrypted data file may be downloaded from the cloud server and a password may be acquired by use of an electronic mail.

Since various processes for encrypting and decrypting in this embodiment can be realized by use of a computer program, the same effect as that of this embodiment can be easily realized by installing the computer program in a normal computer and executing the same via a computer-readable storage medium that stores the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an acquisition module configured to acquire a first data file which is encrypted and a first character string corresponding to the first data file;
a first generator configured to generate first handwriting information comprising a plurality of stroke data corresponding to a plurality of strokes, wherein the first handwriting information is obtainable by inputting the first character string by handwriting;
a second generator configured to generate a first key using the first handwriting information; and
an encrypting processor configured to decrypt the first data file using the first key.

2. The apparatus of claim 1, wherein the first character string is attached to the first data file encrypted and the acquisition module is configured to collectively acquire the first data file encrypted and the first character string.

3. The apparatus of claim 1, wherein the acquisition module is configured to acquire the first data file and the first character string using different methods.

4. The apparatus of claim 1, wherein the second generator is configured to be able to generate a key different from the first key when the first character string is wrote with a different handwriting.

5. The apparatus of claim 1, wherein the acquisition module is configured to acquire second handwriting information comprising a plurality of stroke data corresponding to a plurality of strokes obtained by inputting a second character string by handwriting, the second generator is configured to generate a second key using the second handwriting information, and the encrypting processor is configured to encrypt the second data file using the second key.

6. A decrypting method comprising:
acquiring a first data file which is encrypted and a first character string corresponding to the first data file;
generating first handwriting information comprising a plurality of stroke data, wherein the first handwriting information is obtainable by inputting the first character string by handwriting;
generating a first key using the first handwriting information; and
decrypting the first data file using the first key.

7. A non-transitory computer-readable storage medium storing computer-executable instructions that, if executed, cause a computer to:
acquire a first data file which is encrypted and a first character string corresponding to the first data file;
generate first handwriting information comprising a plurality of stroke data, wherein the first handwriting information is obtainable by inputting the first character string by handwriting;
generate a first key using the first handwriting information; and
decrypt the first data file using the first key.
